(19) United States
(12) Patent Application Publication
(10) Pub. No.: US 2026/0142871 A1
(43) Pub. Date: May 21, 2026

(54) SYSTEMS AND METHODS FOR EVENT-BASED DEVICE IDENTITY VERIFICATION ENCODER-DECODER MODELS

(71) Applicant: Nile Global, Inc., San Jose, CA (US)

(72) Inventor: Ebrahim Safavi, San Jose, CA (US)

(21) Appl. No.: 18/952,711

(22) Filed: Nov. 19, 2024

(51) Int. Cl. H04L 41/069; G06N 3/0455; H04L 9/40

(52) U.S. Cl. CPC H04L 41/069; G06N 3/0455; H04L 63/1466

(57) ABSTRACT

Network events may be mapped to time sequences of network event type identifiers that may be used by an encoder-decoder model to determine if a network device is authentic or is a spoofing device. The network events may fall into broad categories referred to as event types and the time sequence of event types, which includes the timing between events, may be different for authentic devices compared to spoofing devices. An encoder-decoder model may be trained to detect those differences. In an example, training sets may be generated from network event logs and used to train a sequence-to-sequence RNN type encoder-decoder model and thereby produce a trained event-based device identity verification model that may thereafter be deployed for detecting spoofing devices attempting to or having access to a computer network.

### TECHNICAL FIELD

The systems and methods relate to computer networks, wireless networks, WiFi networks, network device interactions with computer networks, network events, authentication, and verification. The systems and methods also relate to using time sequences of events to verify the identity of network devices communicating with a network.

### BACKGROUND

Wireless networks such as WiFi networks have been widely deployed and are widely used. The Institute of Electrical and Electronics Engineers (IEEE) has produced and maintains the standards for WiFi. These standards are identified as the 802.11 standards. The 802.11 family of standards specify many aspects of WiFi communications, such as the media access control (MAC) address that may be used as a device identifier. Hardware identifiers are often used by wireless networks for restricting network access to authentic devices that are approved for accessing the network. Adversaries may attempt to access the wireless networks through numerous attack vectors. Such attacks may include spoofing attacks where an approved device is mimicked by a network device, sometimes called a spoofing device, that the adversary controls. For example, a spoofing device may attempt to access a WiFi network by using the MAC address of an authentic device. Systems and methods for identifying authentic devices and spoofing devices are needed.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

One aspect of the subject matter described in this disclosure can be implemented by a method. The method may include storing event type records that include a plurality of device identifiers corresponding to a plurality of event type identifiers, the device identifiers identifying a plurality of network devices and the event type identifiers identifying types of network events associated with the network devices, instantiating an encoder-decoder model, producing the trained event-based device identity verification model by using the event type records to train the encoder-decoder model to produce an output time sequence of the event type identifiers that predicts upcoming event types for one of the network devices in response to receiving past event types for the one of the network devices, and storing the trained event-based device identity verification model.

Another aspect of the subject matter described in this disclosure can be implemented by a system. The system may include a processor and a memory configured to produce a trained event-based device identity verification model, wherein producing the trained event-based device identity verification model includes storing event type records that include a plurality of device identifiers corresponding to a plurality of event type identifiers, the device identifiers identifying a plurality of network devices and the event type identifiers identifying types of network events associated with the network devices, instantiating an encoder-decoder model, producing the trained event-based device identity verification model by using the event type records to train the encoder-decoder model to produce an output time sequence of the event type identifiers that predicts upcoming event types for one of the network devices, and storing the trained event-based device identity verification model.

Yet another aspect of the subject matter described in this disclosure can be implemented by a non-transitory computer storage medium storing computer readable instructions. The computer readable instructions may, when executed on one or more processors, implement a method that includes storing event type records that include a plurality of device identifiers corresponding to a plurality of event type identifiers, the device identifiers identifying a plurality of network devices and the event type identifiers identifying types of network events associated with the network devices, instantiating an encoder-decoder model, producing a trained event-based device identity verification model by using the event type records to train the encoder-decoder model to produce a output time sequence of the event type identifiers that predicts upcoming event types for one of the network devices in response to receiving past event types for the one of the network devices, and storing the trained event-based device identity verification model.

In some implementations of the methods and devices the device identifiers are media access control addresses of the network devices. In some implementations of the methods and devices each of the event type records includes one of the device identifiers and one of the event type identifiers. In some implementations of the methods and devices each of the event type records includes event timestamp data, and the event timestamp data is used to train the encoder-decoder model. In some implementations of the methods and devices training the encoder-decoder model includes using the event timestamp data to produce position encodings that are used to train the encoder-decoder model. In some implementations of the methods and devices a first one of the network events associated with the one of the network devices occurred at a first time, a second one of the network events associated with the one of the network devices occurred at a second time, and one of the position encodings is a scalar that indicates an amount of time between the first one of the network events and the second one of the network events. In some implementations of the methods and devices, the method may further include accessing a network event log that includes event records that include the device identifiers corresponding to event metadata, and producing the event type records by mapping the event metadata to one of the event type identifiers.

In some implementations of the methods and devices training the encoder-decoder model includes using the event type records to produce an input time sequence of the event type identifiers corresponding to one of the device identifiers, and the encoder-decoder model includes an encoder that is configured to receive an encoder input that is included in the input time sequence of the event type identifiers. In some implementations of the methods and devices the encoder-decoder model includes a decoder that is configured to produce the output time sequence of the event type identifiers. In some implementations of the methods and devices the input time sequence of the event type identifiers includes the encoder input and a decoder input. In some implementations of the methods and devices producing the trained event-based device identity verification model includes using the event type records to produce a desired time sequence of the event type identifiers corresponding to one of the device identifiers. Furthermore, training the encoder-decoder model may include calculating a distance between the desired time sequence and the output time sequence of the event type identifiers, and using the distance to update the encoder-decoder model.

In some implementations of the methods and devices the device identifiers are media access control addresses of the network devices. In some implementations of the methods and devices each of the event type records includes one of the device identifiers and one of the event type identifiers. In some implementations of the methods and devices each of the event type records includes event timestamp data, and training the encoder-decoder model includes using the event timestamp data to produce position encodings that are used to train the encoder-decoder model.

In some implementations of the methods and devices a first one of the network events associated with the one of the network devices occurred at a first time, a second one of the network events associated with the one of the network devices occurred at a second time, and one of the position encodings is a scalar that indicates an amount of time between the first one of the network events and the second one of the network events. In some implementations of the methods and devices the encoder-decoder model includes an encoder that is configured to receive an encoder input that is included in an input time sequence of event type identifiers, and the encoder-decoder model includes a decoder that is configured to produce the output time sequence of the event type identifiers. In some implementations of the methods and devices the encoder-decoder model produces the output time sequence of the event type identifiers in response to receiving an input time sequence of event type identifiers, and the input time sequence of the event type identifiers includes a desired time sequence of the event type identifiers. Furthermore, training the encoder-decoder model may include calculating a distance between the desired time sequence of the event type identifiers and the output time sequence of the event type identifiers, and using the distance to update the encoder-decoder model.

### BRIEF DESCRIPTION OF THE DRAWINGS

FIG. 1 is a high-level block diagram illustrating an example of a network that uses a trained event-based device identity verification model, according to some aspects.

FIG. 2 is a high-level block diagram illustrating an example of producing event type records from network event reports, according to some aspects.

FIG. 3 is a high-level block diagram illustrating an example of a host machine that may implement a trained event-based device identity verification model, according to some aspects.

FIG. 4 is a high-level block diagram illustrating an example of a software system according to some aspects.

FIG. 5 is a high-level block diagram illustrating an example of producing a time sequence of event type identifiers and producing position encodings, according to some aspects.

FIG. 6 is a high-level block diagram illustrating an example of an encoder-decoder model implementing an event-based device identity verification model, according to some aspects.

FIG. 7 is a high-level block diagram illustrating an example of calculating a prediction error, according to some aspects.

FIG. 8 is a high-level flow diagram illustrating an example of training an encoder-decoder model to implement an event-based device identity verification model, according to some aspects.

FIG. 9 is a high-level flow diagram illustrating an example of producing an identity verification decision, according to some aspects.

FIG. 10 is a high-level flow diagram illustrating an example of producing position encodings by normalizing timestamps, according to some aspects.

FIG. 11A, FIG. 11B, FIG. 11C, FIG. 11D and FIG. 11E are high-level conceptual diagrams illustrating an example of a table that maps events to event type identifiers, according to some aspects.

FIG. 12 is a high-level flow diagram illustrating an example of a method that produces an identity verification decision, according to some aspects.

FIG. 13 is a high-level flow diagram illustrating an example of a method that produces a trained event-based device identity verification model, according to some aspects.

FIG. 14 a high-level flow diagram illustrating an example of a cloud service, according to some aspects.

### DETAILED DESCRIPTION

It will be readily understood that the components of the examples as generally described herein and illustrated in the appended figures could be arranged and designed in a wide variety of different configurations. Thus, the following more detailed description of various examples, as represented in the figures, is not intended to limit the scope of the present disclosure but is merely representative of various examples. While the various aspects of the examples are presented in drawings, the drawings are not necessarily drawn to scale unless specifically indicated.

The described examples are to be considered in all respects only as illustrative and not restrictive. The scope of the claimed matter is therefore indicated by the appended claims rather than by this detailed description. All changes which come within the meaning and range of equivalency of the claims are to be embraced within their scope.

Reference throughout this specification to features, advantages, or similar language does not imply that all the features and advantages that may be realized should be realized in any single example. Rather, language referring to the features and advantages is understood to mean that a specific feature, advantage, or characteristic described in connection with an example is included in at least one implementation. Thus, discussions of the features and advantages, and similar language, throughout this specification may, but do not necessarily, refer to the same example.

Furthermore, the described features, advantages, characteristics, and aspects may be combined in any suitable manner in one or more examples. One skilled in the relevant art will recognize from the description herein that one example may be practiced without one or more of the specific features or advantages of another example. In other instances, additional features and advantages may be recognized in certain examples that may not be present in all examples.

Reference throughout this specification to “one example”, “an example”, or similar language means that a particular feature, structure, or characteristic described in connection with the indicated example is included in at least one example. Thus, the phrases “in one example”, “in an example”, and similar language throughout this specification may, but do not necessarily, all refer to the same example.

An adversary can attack a computer network via a spoofing attack in which a spoofing device uses the hardware identifier of an authentic device. The authentic device is a network device that is allowed to use the computer network. The spoofing device is a network device that mimics the authentic device in order to connect to the computer network. WiFi networks may be attacked by a spoofing device using the MAC address of an authentic device. Network events occur when network devices, authentic or not, interact with the network. The sequence of events associated with a network device may be used to identify spoofing devices and authentic devices. Machine learning models, specifically encoder-decoder models, may therefore implement event-based identification of network devices. Network devices identified as spoofing devices may be denied network access, may be given a restricted level of network access, etc. Network devices identified as authentic devices may continue accessing the network.

The sequences of events associated with networking devices may be stored in network event logs, each entry including a timestamp indicating when the event occurred, the device identifier (e.g., the MAC address) of the network device associated with the event, and event metadata providing further event details. The sequence of events for a specific network device may be used to produce input time sequences of event type identifiers that are used to train an encoder-decoder model to predict sequences of future event types. After training, differences between the predicted sequences and the observed sequences may be used to identify spoofing devices and authentic devices.

Machine learning has made stunning advances in recent years. One such advance is the encoder-decoder network, introduced in 2014 through two influential papers: “Sequence to Sequence Learning with Neural Networks” by Sutskever, Vinyals, and Le; and “Learning Phrase Representations using RNN Encoder-Decoder for Statistical Machine Translation” by Cho et al. As such, RNN encoder-decoder models were introduced in 2014. Development continued. Two additional encoder-decoder models were introduced in 2017: Convolutional Neural Network (CNN) encoder-decoder models; and transformer based encoder-decoder models. Transformer based models were introduced in the paper: “Attention is All You Need” by Ashish Vaswani, Noam Shazeer, Niki Parmar, Jakob Uszkoreit, Llion Jones, Aidan N. Gomez, Łukasz Kaiser, and Illia Polosukhin, published in the proceedings of the Neural Information Processing Systems (NIPS) conference in 2017. Since then, a great many different encoder-decoder models have been introduced, including hybrid architectures that combine different types of encoder and decoder layers such as RNN layers in combination with CNN or transformer layers, etc. In testing, a transformer based encoder-decoder has produced useful levels of device identification of authentic devices or spoofing devices. The transformer used had 4 layer multiheaded attention, eight attention heads, a model dimension of 512, an embedding dimension of 128, a 0.2 dropout rate, an input length of 100(M=100 ), and an output length of 50 (N=50).

In 2024, machine learning libraries (e.g., pytorch, tensorflow, etc.) and large language models (LLMs) have made the enablement of machine learning applications very approachable. For example, an initial step of project development may be to ask a LLM (e.g., “Claude” at https://claude.ai”) to provide a python program for a 4 layer RNN encoder-decoder for sequence to sequence prediction having 100 encoder inputs and 50 decoder inputs. In response, Claude produces a python program that, after some trouble shooting, may be the core of a machine learning application that uses a RNN based encoder-decoder model. Similar requests may be made for other encoder-decoder models such as CNN models, transformer models, hybrid models, etc. Regardless of whether an experienced machine learning practitioner, an inexperienced practitioner with an LLM helper, or some other entity programs and trains the machine learning model, the result is a useful application. It is a useful application for detecting spoofing devices. The useful application is not, however, limited to detecting spoofing devices.

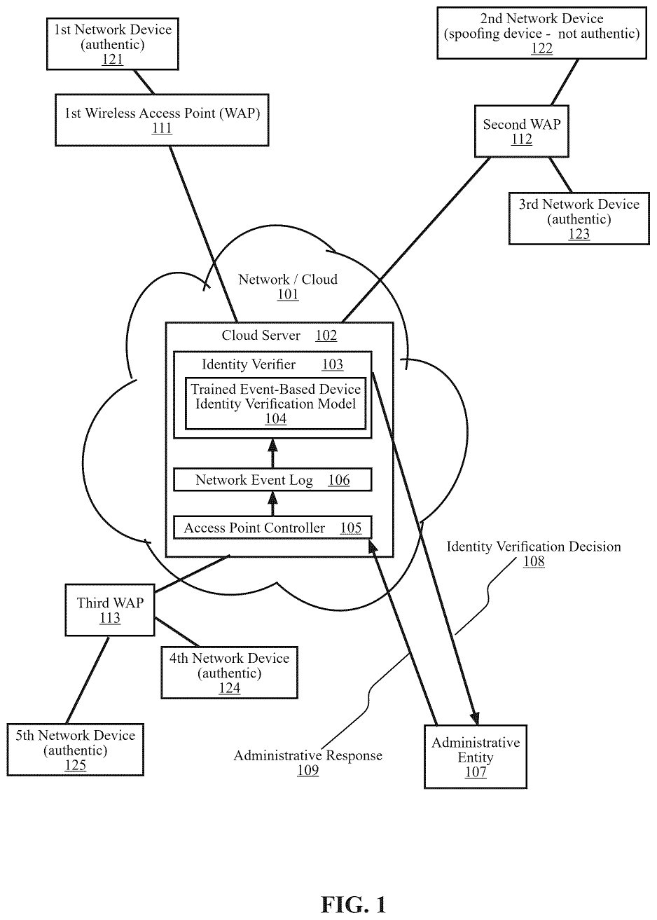

FIG. 1 is a high-level block diagram illustrating an example of a network 101 that uses a trained event-based device identity verification model, according to some aspects. The network 101 may include wireless access points (WAPs) such as a first wireless access point (WAP) 111, a second WAP 112, and a third WAP 113. Network devices may connect to the network 101 via the WAPs. The first network device 121 is shown connecting to the network via the first WAP 111. The second network device 122 and the third network device 123 are shown connecting to the network via the second WAP 112. The fourth network device 124 and the fifth network device 125 are shown connecting to the network via the third WAP 113. The first network device 121, the third network device 123, the fourth network device 124, and the fifth network device 125 may be authentic network devices that should have full access to the network 101. The second network device 122 may be a spoofing device that should not have access to the network 101.

A cloud server 102 may include an access point controller 105, a network event log 106, and an identity verifier 103. The access point controller 105 may configure the WAPs to provide network services to the authentic network devices and to block the spoofing devices. The access point controller may also store event records in the network event log 106 in response to receiving network event reports. The WAPs and other network devices (e.g., DHCP server, load balancer, etc.) may generate the network event reports. The identity verifier 103 may process the event log and provide input data to a trained event-based device identity verification model 104. The trained event-based device identity verification model 104 may produce an output that indicates whether or not the second network device 122 is probably a spoofing device. In response, the identity verifier 103 may send an identity verification decision 108 to an administrative entity 107. The administrative entity may respond to the identity verification decision 108 by sending an administrative response to the access point controller 105. In an example, the identity verifier may determine that the second network device 122 is probably a spoofing device and the administrative response may instruct the access point controller to deny network access for the second network device 122. The administrative entity 107 may be a server that allows or denies network access according to a set of rules. In some examples, the cloud server 102 or the access point controller 105 may include the administrative entity 107. In some examples, the identity verifier 103, the trained event-based device identity verification model 104, and the access point controller 105 are implemented as software-as-a-service and may be instantiated in different servers.

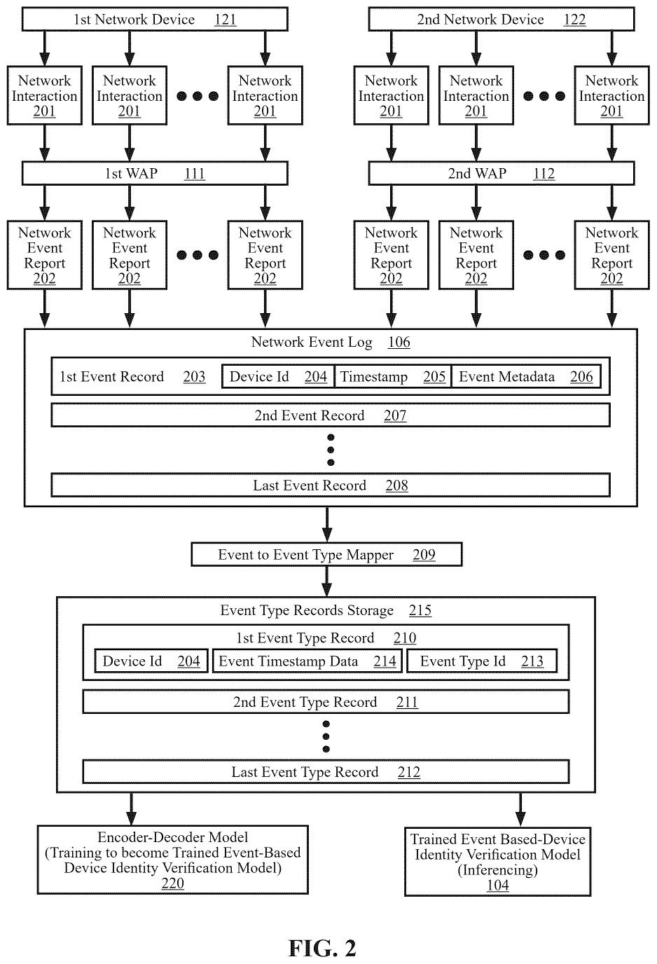

FIG. 2 is a high-level block diagram illustrating an example of producing event type records 203, 211, 212 from network event reports 202, according to some aspects. The first network device 121 and the second network device 122 interact with the WAPs via numerous network interactions 201. The WAPs may be configured to report all, some, or none of the network interactions to a logging device. The WAPs may report network interactions 201 to the logging device by sending network event reports 202 to the logging device. The network event reports may include the device identifiers of the network devices interacting with the network, timestamps indicating the times at which the network interactions occurred, and event metadata describing the network interactions. The device identifiers of the network devices may be the MAC addresses of the network devices. In the example illustrated in FIG. 1, the logging device is the access point controller. The logging device may store event records in the network event log 106 in response to receiving the network event reports 202. The network event log is shown storing a first event record 203, a second event record 207, and a last event record 208. The event records may include a device identifier 204 corresponding to a timestamp 205 and to event metadata 206. The timestamp 205 indicates when the event occurred. The device identifier 204 (e.g., the MAC address) identifies the network device associated with the event. The event metadata 206 provides further event details. An event to event type mapper 209 may create event type records 210, 211, 212 by accessing the event log and processing the event records. The event type records may be stored in event type records storage 215. An event type record can include a device identifier 204, event timestamp data 214, and an event type identifier 213. In an example, the event to event type mapper 209 produces the first event type record 210 by processing first event record 203. The first event type record includes a device identifier 204 corresponding to event timestamp data 214 and to an event type identifier 213. The device identifier 204 in the first event type record 210 may be the same as the device identifier 204 in the first event record 203. The event timestamp data 214 in the first event type record 210 may be the same as the timestamp 205 in the first event record 203 or may be data that has been derived from the timestamp 205. In an example, the timestamp in a previous event record having the same device identifier 204 may be subtracted from the timestamp 205 in the first event record 203 to produce a time delta that is stored as the event timestamp data 214. As such, the event timestamp data 214 may indicate an amount of time between the first one of the network events and the second one of the network events. The event type records may be used for training an encoder-decoder model 220 that becomes, after training, a trained event-based device identity verification model. A trained event-based device identity verification model may use the event type records 104 for identifying spoofing devices.

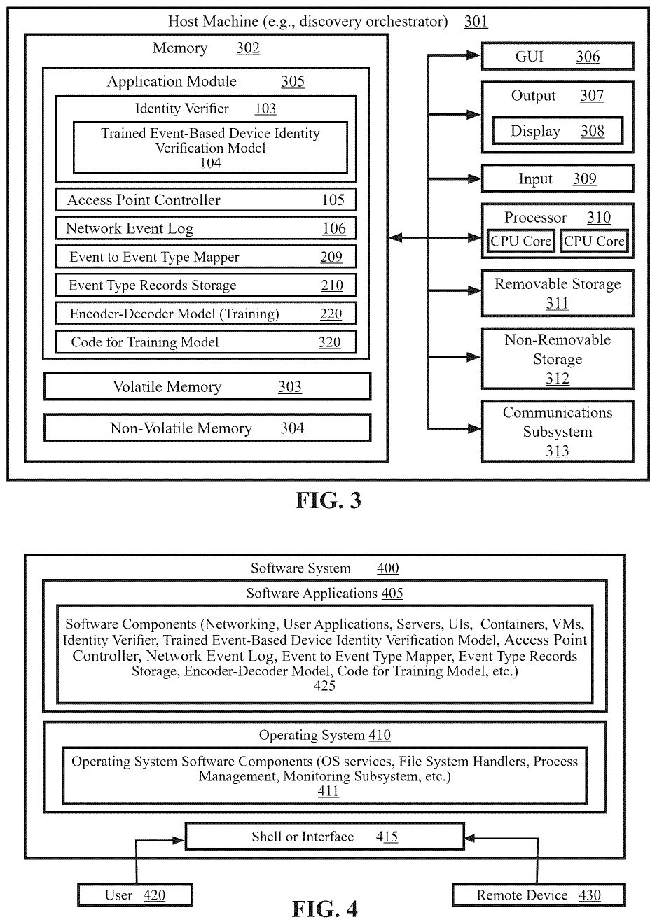

FIG. 3 is a high-level block diagram illustrating an example of a host machine that may implement a trained event-based device identity verification model 104, according to some aspects. A computing device in the form of a host machine 301 configured to interface with controllers, peripheral devices, and other elements may include one or more processing units 310 coupled to memory 302, removable storage 311, and non-removable storage 312. Memory 302 may include volatile memory 303 and non-volatile memory 304. Host machine 301 may include or have access to a computing environment that includes a variety of transitory and non-transitory computer storage media such as volatile memory 303 and non-volatile memory 304, removable storage 311 and non-removable storage 312. Examples of a computer storage medium include random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions and data. Of the listed computer storage media, volatile memory, and most RAM, such as dynamic RAM (DRAM), are transitory computer storage media while the others are considered non-transitory computer storage media.

Host machine 301 may include, or have access to, a computing environment that includes input 309, output 307, and a communications subsystem 313. The host machine 301 may operate in a networked environment using the communications subsystem 313 to connect to one or more remote computers, remote sensors and/or controllers, detection devices, hand-held devices, multi-function devices (MFDs), speakers, mobile devices, tablet devices, mobile phones, wireless access points, smartphones, or other such devices. The remote computer may also be a personal computer (PC), server, router, network PC, radio frequency identification (RFID) enabled device, a peer device or other common network node, etc. The communication connection may connect to a local area network (LAN), a wide area network (WAN), wireless network, Bluetooth connection, or other networks.

Output 307 may be provided as a computer monitor or flat panel display but may include any output device. Output 307 and/or input 309 may include a data collection apparatus associated with host machine 301. In addition, input 309, which may include a computer keyboard, a pointing device such as a computer mouse, computer trackpad, or touch screen allows a user to instruct host machine 301. A user interface can be provided using output 307 and input 309. Output 307 may include a display 308 for displaying data and information for a user, or for interactively displaying a graphical user interface (GUI) 306. A GUI is typically responsive to user inputs entered through input 309 and typically displays images and data on display 308.

Note that the term “GUI” generally refers to a type of environment that represents programs, files, options, and so forth by means of graphically displayed icons, menus, and dialog boxes on a computer monitor screen or smartphone screen. A user can interact with the GUI to select and activate such options by directly touching the screen and/or pointing and clicking with a user input device 309 such as, for example, a pointing device such as a mouse, and/or with a keyboard. A particular item can function in the same manner to the user in all applications because the GUI provides standard software routines (e.g., the application module 305 can include program code in executable instructions, including such software routines) to handle these elements and report the user's actions.

Computer-readable instructions (e.g., program code in application module 305), can include or be representative of software routines, software subroutines, software objects, etc. described herein, are stored on a computer-readable medium (e.g., non-transitory computer storage media or transitory computer storage media) and are executable by the processor device (also called a processing unit) 310 of host machine 301. The application module 305 may include computer code and data including, for example, identity verifier 103, trained event-based device identity verification model 104, access point controller 105, network event log 106, event to event type mapper 209, event type records storage 215, encoder-decoder model 220 in training or to be trained, and code for training the model 320. The computer code may read, write, or modify data. A hard drive, CD-ROM, RAM, flash memory, and a USB drive are just some examples of a computer storage medium.

FIG. 4 is a high-level block diagram illustrating an example of a software system 400 according to some aspects. The software system 400 may be employed for directing the operation of data-processing systems such as host machine 301. Software applications 405 may be stored in memory 302, on removable storage 311 or on non-removable storage 312, and generally includes and/or is associated with an operating system 410 and a shell or interface 415. One or more application programs may be “loaded” (i.e., transferred from removable storage 311 or non-removable storage 312 into the memory 302) for execution by the host machine 301. Application programs 405 can include software components 425 such as software modules, software subroutines, software objects, network code, user application code, server code, UI code, container code, virtual machine (VM) code, identity verifier code and data, trained event-based device identity verification model code and data, access point controller code and data, network event log, event to event type mapper code and data, event type records storage, encoder-decoder model code and data, code for training the model, etc. The software system 400 can have multiple software applications each containing software components. The host machine 301 can receive user commands and data through interface 415, which can include input 309, output 307, and communications connection 313 accessible by a user 420 or remote device 430. These inputs may then be acted upon by the host machine 301 in accordance with instructions from operating system 410 and/or software applications 405 and any software components 425 thereof. The operating system may include operating system software components 411 such as operating system services, file system handlers, process management, monitoring subsystem, etc.

Generally, software components 425 can include, but are not limited to, routines, subroutines, software applications, programs, modules, objects (used in object-oriented programs), executable instructions, data structures, etc., that perform specific tasks or implement specific abstract data types and instructions. Moreover, those skilled in the art will appreciate that elements of the disclosed methods and systems may be practiced with other computer system configurations such as, for example, hand-held devices, mobile phones, smartphones, tablet devices, multi-processor systems, microcontrollers, printers, copiers, fax machines, multi-function devices, data networks, microprocessor-based or programmable consumer electronics, networked personal computers, minicomputers, mainframe computers, servers, medical equipment, medical devices, etc.

Note that the terms “component” and “module” as utilized herein may refer to one of or a collection of routines and data structures that perform a particular task or implement a particular data type. Applications and components may be composed of two parts: an interface, which lists the constants, data types, variables, and routines that can be accessed by other modules or routines; and an implementation, which is typically private (accessible only from within the application or component) and which includes source code that implements the routines in the application or component. The terms application or component may also simply refer to an application such as a computer program designed to assist in the performance of a specific task such as word processing, accounting, etc. Components can be built or realized as special purpose hardware components designed to equivalently assist in the performance of a task.

The interface 415 can include a graphical user interface 306 that may display results, whereupon a user 420 or remote device 430 may supply additional inputs or terminate a particular session. In some examples, operating system 410 and GUI 306 can be implemented in the context of a “windows” system. It can be appreciated, of course, that other types of systems are possible. For example, rather than a traditional “windows” system, other operating systems such as, for example, a real time operating system (RTOS) more commonly employed in wireless systems may also be employed with respect to operating system 410 and interface 415. The software application 405 can include, for example, software components 425 that may include instructions for carrying out steps or logical operations such as those shown and described herein.

The description herein is presented with respect to examples that may be implemented in the context of, or require the use of, a data processing system such as host machine 301, in conjunction with program code in an application module 305 in memory 302, software system 400, or host machine 301. The disclosed examples, however, are not limited to any specific application or environment. Instead, those skilled in the art will find that the systems and methods described herein may be advantageously applied to a variety of system and application software including database management systems, word processors, etc. Moreover, the examples may be implemented on a variety of different platforms including Windows, Macintosh, UNIX, LINUX, Android, Arduino, etc. Therefore, the descriptions of the examples which follow are for purposes of illustration and not considered a limitation.

Host machines 301 and software systems 400 can take the form of or run as virtual machines (VMs) or containers that run on physical machines. A VM or container typically supplies an operating environment, appearing to be an operating system, to program code in an application module and software applications 405 running in the VM or container. A single physical computer can run a collection of VMs and containers. In fact, an entire network data processing system including a multitude of host machines 301, LANs and perhaps even WANs or portions thereof can all be virtualized and running within a single computer (or a few computers) running VMs or containers. Those practiced in cloud computing are practiced in the use of VMs, containers, virtualized networks, and related technologies.

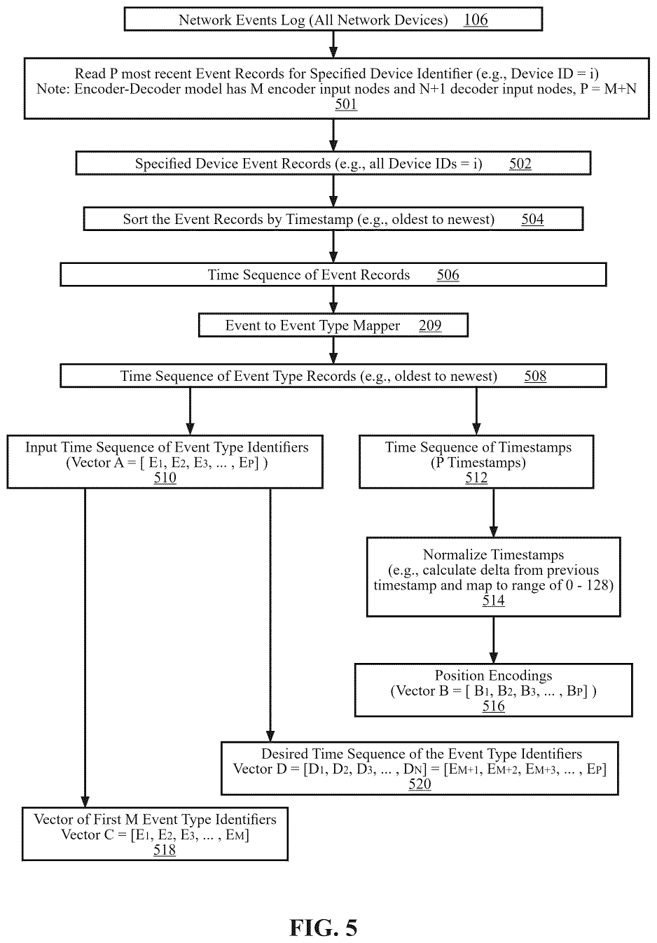

FIG. 5 is a high-level block diagram illustrating an example of producing an input time sequence of event type identifiers 510 and producing position encodings 516, according to some aspects. A network events log 106 may contain event records for all the network devices that have communicated with the network. At block 501, the P (P is an integer) most recent event records for a specified device identifier (e.g., device id=i) are read from the network events log 106. Here, P is the number of data points that will be provided to the encoder-decoder model. The encoder-decoder model has M encoder input nodes and N decoder input nodes, P=M+N. The P event records 502 for the specified device are sorted by timestamp at block 504 to obtain a time sequence of event records 506. A time sequence is an ordered list of events or observations where the time component simply determines the order and in which the actual time intervals between events may be irregular or irrelevant. In contrast, a time series is a sequence of data points recorded at regular time intervals and for which the timing itself may be a crucial component of the data and analysis. The time sequence of event records may be submitted to an event to event type mapper 209 that analyzes the event records to thereby produce a time sequence of event type records 508. The event types may be determined from the event metadata in the event records.

The time sequence of event type records 508 includes P event type records corresponding to the P most recent event records for the device specified at block 501. Vector A is an input time sequence of event type identifiers 510 that may be produced by reading the event types in the time sequence of event type records 508, being careful to preserve the order in which the event types occur. Vector C 518 is the first M event type identifiers in Vector A. As discussed above, the encoder of the encoder-decoder model is configured to receive M inputs. Vector C may therefore be an encoder input. Vector D 520 is the final N event type identifiers in Vector A. As discussed above, the decoder of the encoder-decoder model is configured to receive N inputs where the first value is a start symbol. Vector D may therefore be a decoder input once prepended with the start symbol (vector now has N+1 elements) and the final vector element removed (vector now has N elements). Vector D is also the desired time sequence of the event type identifiers. The encoder-decoder model is trained by minimizing the distance between the encoder-decoder output and the desired time sequence of the event type identifiers.

A time sequence of timestamps 512 may be produced by reading the timestamp data in the time sequence of event type records 508, being careful to preserve the order in which the timestamps occur. The timestamps may be normalized at block 514. In an example, the timestamps may be normalized by subtracting the previous timestamp to thereby calculate the timestamp delta and then mapping the delta to a number in the range 0-128. For example, the equation 128*delta/maxDelta performs such a mapping. Here, maxDelta is a number selected as the value that will map to 128. All deltas larger than maxDelta may be mapped to 128. Vector B, the position encodings 516, is the time sequence of normalized timestamps, being careful to preserve the order in which the normalized timestamps occur.

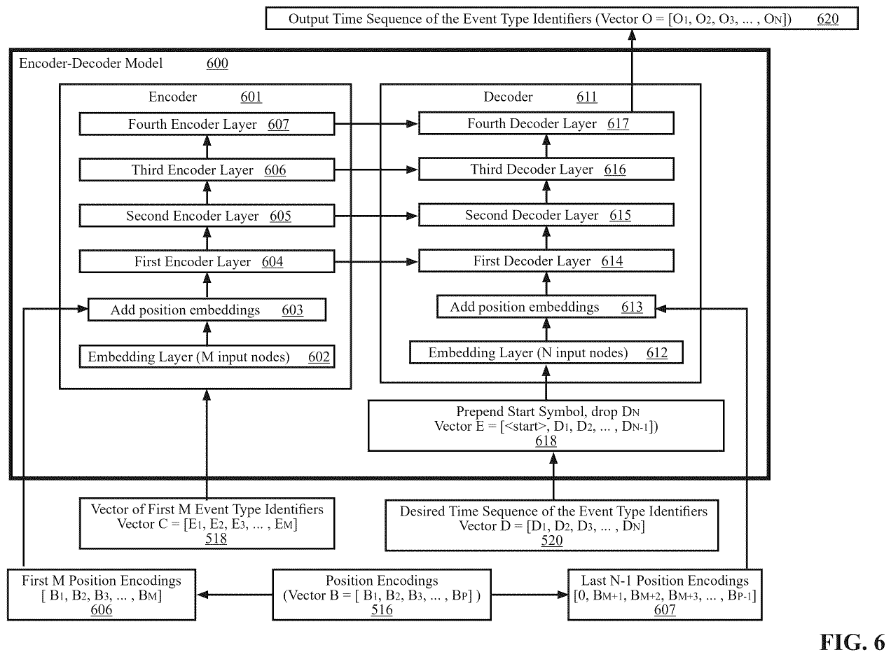

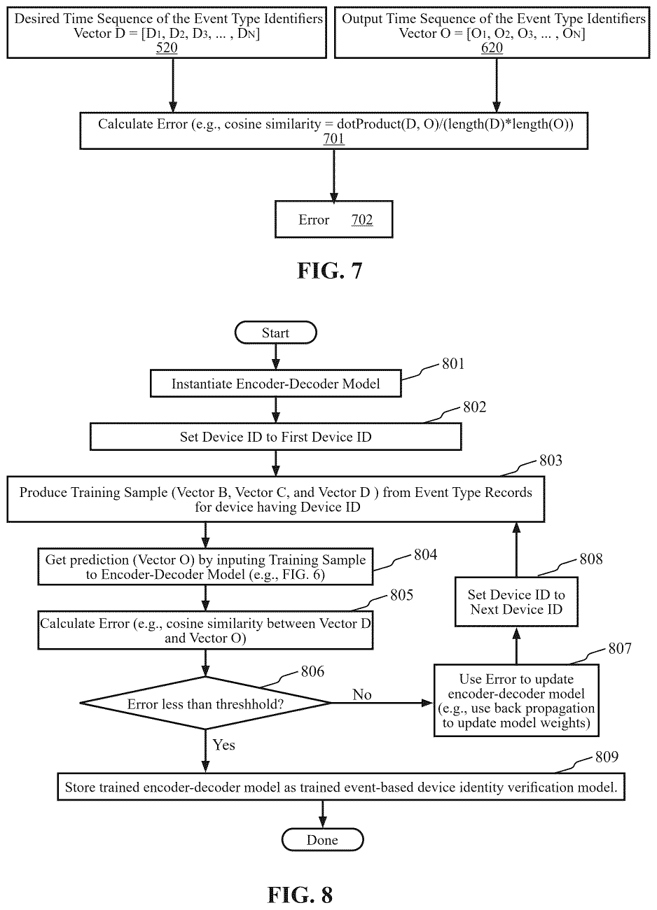

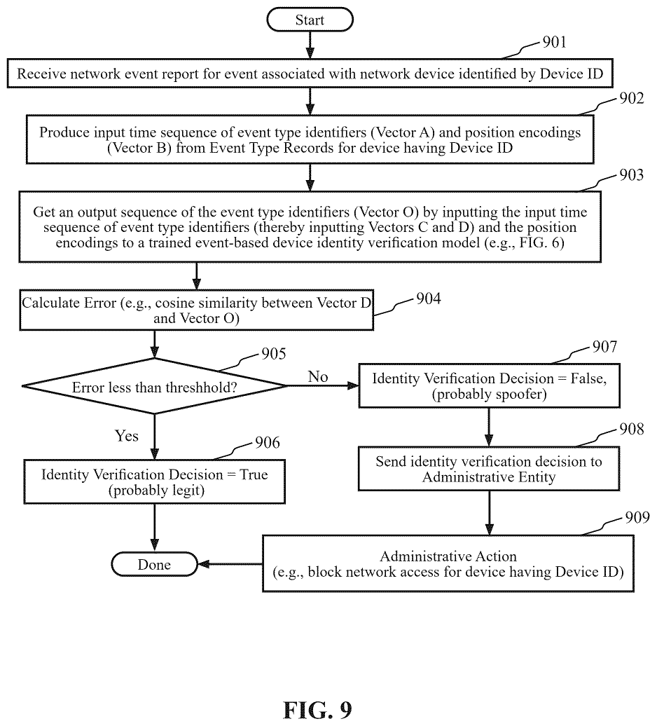

FIG. 6 is a high-level block diagram illustrating an example of an encoder-decoder model 600 implementing an event-based device identity verification model, according to some aspects. The encoder-decoder model 600 includes an encoder 601 and a decoder 611. The encoder 601 includes an embedding layer 602, block 603 that adds position encodings to the embeddings produced by the encoder's embedding layer 602, and encoder layers. Here, there are four encoder layers: a first encoder layer 604, a second encoder layer 605, a third encoder layer 606, and a fourth encoder layer 607. The decoder 611 includes an embedding layer 612, block 613 that adds position encodings to the embeddings produced by the decoder's embedding layer 612, and decoder layers. Here, there are four decoder layers: a first decoder layer 614, a second decoder layer 615, a third decoder layer 616, and a fourth decoder layer 617. Note that in some examples the numbers of encoder layers and decoder layers may be set by a parameter in a pytorch call that instantiates the encoder-decoder model. The example illustrated in FIG. 6 shows a prepend block 618 that produces the decoder input, vector E, by prepending the start symbol to vector D and removing the last element in vector D. Here, the prepend block 618 is shown inside the encoder-decoder model 600 to simplify the description. Many practitioners consider the prepend block 618 to be outside the encoder-decoder model 600.

The inputs to the encoder-decoder model may include the input time sequence of event type identifiers 510 (vector A, which includes vector C and vector D) and the position encodings 516 (vector B). The embedding layers 602, 612 are layers that convert the input sequence to embeddings. “Embeddings” is a term of art that simply refers to the encoder outputs. At blocks 603 and 613, the position encodings are added to the embeddings. The positionally encoded embeddings are then passed through the layers. The encoder-decoder model 600 produces an output time sequence of event type identifiers 620 in response to receiving the input time sequence of event type identifiers 510 (vector A, which includes vector C and vector D) and the position encodings 516 (vector B). The encoder-decoder model 600 may be trained to minimize the difference between vector O and vector D. When so trained, the encoder-decoder model is a trained event-based device identity verification model that predicts upcoming event types by producing vector O which is a time sequence of event type identifiers identifying types of network events associated with the network device.

FIG. 7 is a high-level block diagram illustrating an example of calculating a prediction error 702, according to some aspects. The desired time sequence of the event type identifiers 520 is a vector, vector D. The output time sequence of the event type identifiers 620 is a vector, vector O. In machine learning, the cosine similarity is commonly used as a measure of the distance, or error, between two vectors. The cosine similarity may be determined by calculating the dot product of the two vectors and then dividing the dot product by the lengths of the two vectors. In the example illustrated in FIG. 7, the cosine similarity is calculated at block 701 to thereby produce the error 702. The cosine similarity is one of the distance measures used as an error measurement in some examples of machine learning applications. Other examples may use one of the other distance measures (e.g., correlation distance, Euclidean distance, etc.) as an error measurement.

FIG. 8 is a high-level flow diagram illustrating an example of a process that trains an encoder-decoder model to implement an event-based device identity verification model, according to some aspects. The process may be performed by the host machine 301 shown in FIG. 3. At block 801, the encoder-decoder model is instantiated (e.g., by calling a class method in pytorch). At block 802, device ID is set to the first device ID. Here, device ID is a variable that may be sequenced through all the device IDs of the known network devices. At block 803, a training sample is produced from the event type records for the device identified by device ID. Referring to FIGS. 5-7, the training sample may be three vectors: vector B, vector C, and vector D. Note that the event type records may be generated from the network event log, as discussed above. At block 804, the output time sequence of the event type identifiers, vector O, is obtained by inputting the training sample to the encoder-decoder model. At block 805, the error (e.g., cosine similarity between vector D and vector O) is calculated. At decision block 806, the error is compared to a threshold value. If the error is less than the threshold value at decision block 806, the process moves to block 809, otherwise the process moves to block 807. At block 809 the encoder-decoder model is saved as a trained event-based device identity verification model. At block 807, the error is used to update the encoder-decoder model. Currently, the most common technique for updating the model is back propagation. Implementations of back propagation are widely available in machine learning libraries such as pytorch and tensorflow. At block 808, device ID is set to the device identifier of the next device before the process loops back to block 803. Note that many machine learning libraries and development environments provide for automatically fetching training samples from training sample sets and for training machine learning models.

FIG. 9 is a high-level flow diagram illustrating an example of a process that produces an identity verification decision, according to some aspects. The process may be run by the host machine 301 illustrated in FIG. 3. At block 901, a network event report is received. The network event is associated with a network device identified by device ID (e.g., the MAC address of the network device). In an example, the network device has connected to an access point and attempted to receive an internet protocol address, thereby generating numerous network events. At block 902, an input time sequence of event type identifiers (e.g., vector A in FIG. 5) and position encodings (e.g., vector B in FIG. 5) is produced. At block 903, an output time sequence of the event type identifiers (vector O) is obtained by inputting the input time sequence of event type identifiers (e.g., inputting vector A, thereby inputting vectors C and D) and the position encodings (e.g., vector B) to a trained event-based device identity verification model (see, e.g., FIG. 6). At block 904, the error between the output time sequence of the event type identifiers and the desired time sequence of the event type identifiers is calculated. At decision block 905, a determination is made by comparing the error to a threshold value. If the error is less than the threshold value at decision block 905, the process moves to block 906 and otherwise moves to block 907. At block 906, an identity verification decision is produced indicating that the device is probably an authorized device. As such, no further actions may be necessary before the process is done. At block 907, an identity verification decision is produced indicating that the device is probably a spoofing device. At block 908, the identity verification decision is sent to an administrative entity. At block 909, an administrative action (e.g., block network access for the device having Device ID) is performed before the process is done.

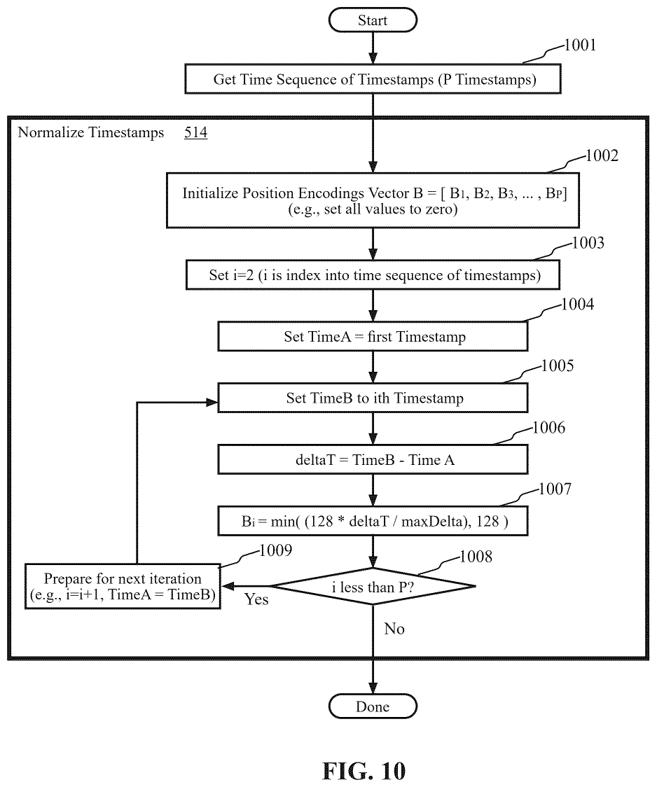

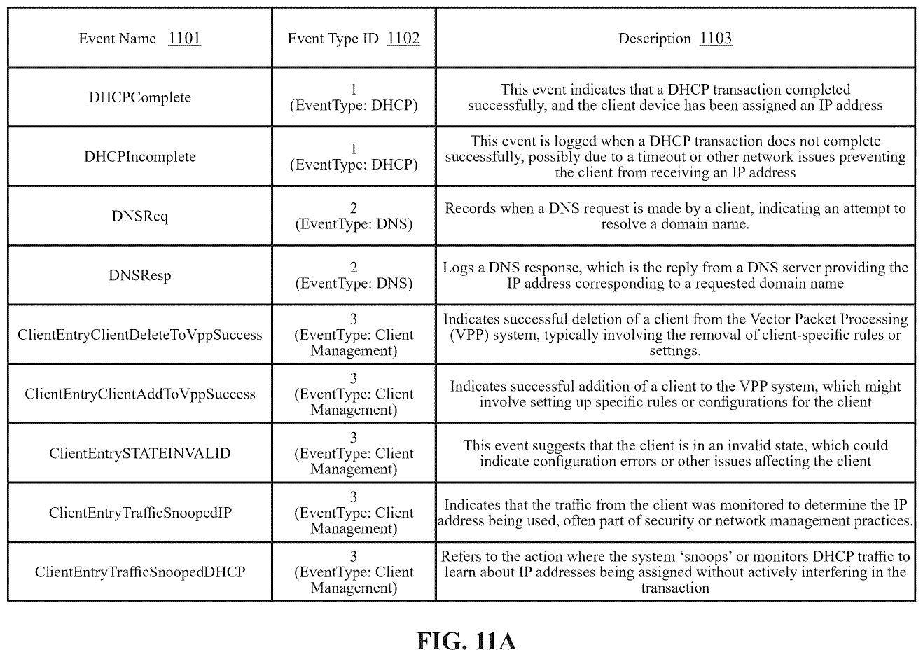

FIG. 10 is a high-level flow diagram illustrating an example of a process that produces position encodings by normalizing timestamps, according to some aspects. The process may be performed by the host machine 301 illustrated in FIG. 3. The process illustrated in FIG. 10 may normalize timestamps as suggested at block 514 of FIG. 5. At block 1001, a time sequence of timestamps (e.g., P time timestamps as shown in FIG. 5) is obtained. At block 1002, a position encoding vector may be initialized (e.g., create a P element vector with all values set to 0). At block 1003, a counter, i, is set to 2. The counter may be used as an index into the sequence of timestamps. At block 1004, timeA is set to equal the first timestamp in the time sequence of timestamps. At block 1005, timeB is set to equal the ith timestamp in the time sequence of timestamps. At block 1006, deltaT is calculated by subtracting timeA from timeB. At block 1007, the ith position encoding is determined. (e.g., set ith position encoding to 128 or to 128*deltaT/maxDelta, whichever is smaller). If i is less than P at decision block 1008, the process moves to block 1009, otherwise the process is done. At block 1009, the process prepares for the next iteration (e.g., set i=i+1 and set timeA=timeB) before looping back to block 1005. The process illustrated in FIG. 10 may produce a time sequence of position encodings where each one of the position encodings is a scalar that indicates an amount of time between the one of the network events associated with one of the network devices and the immediately preceding one of the network events associated with the one of the network devices.

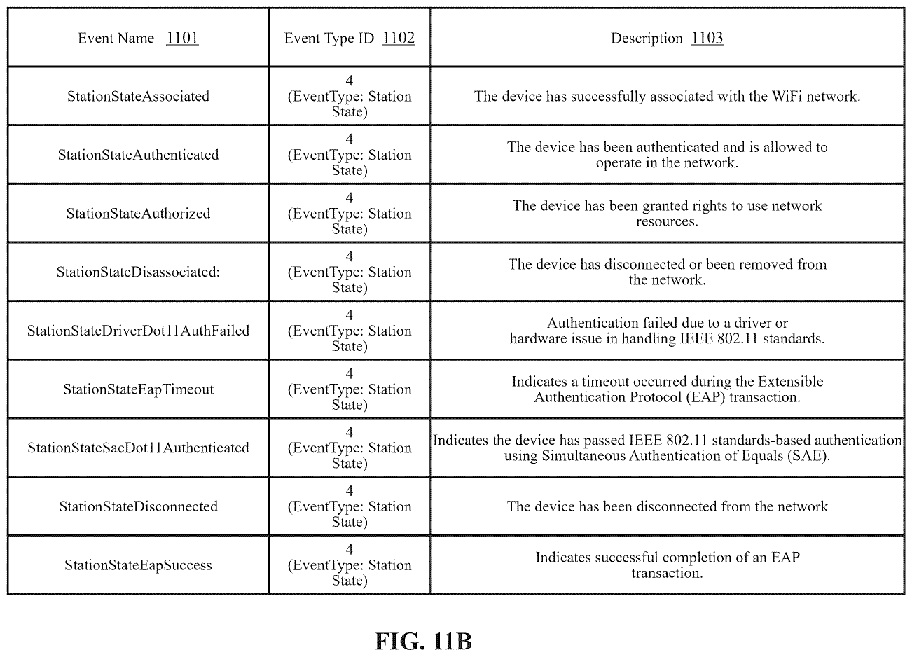

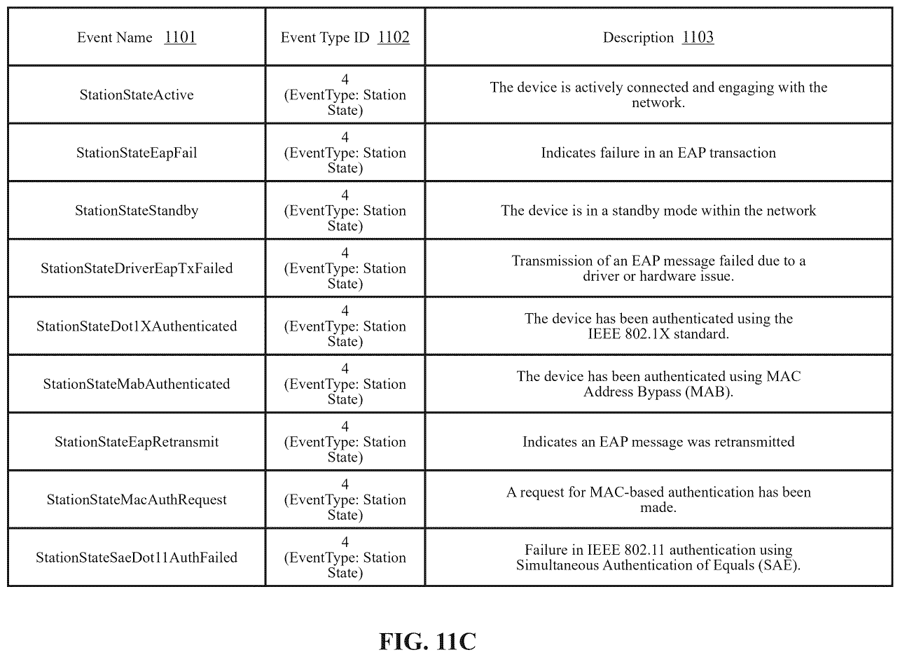

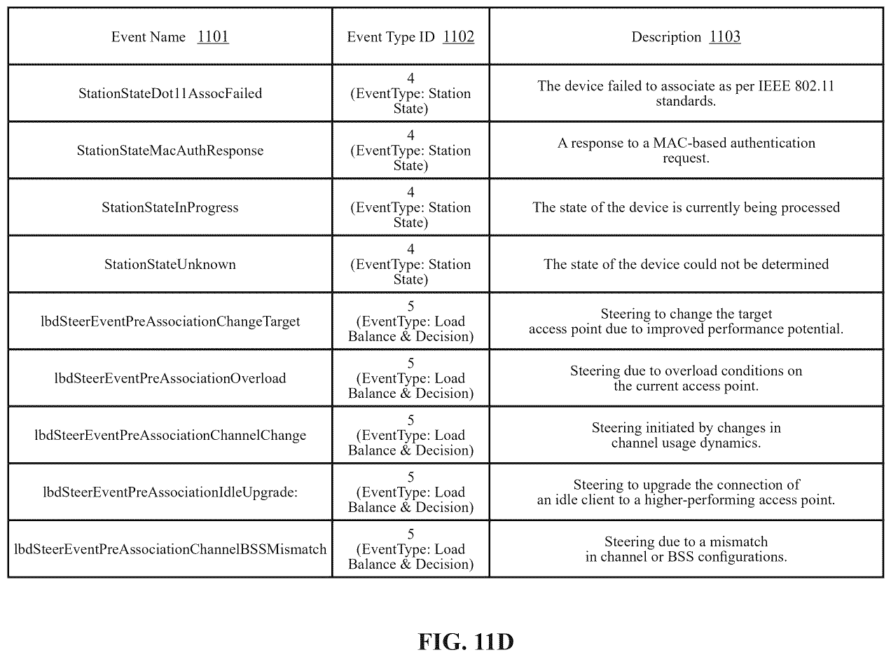

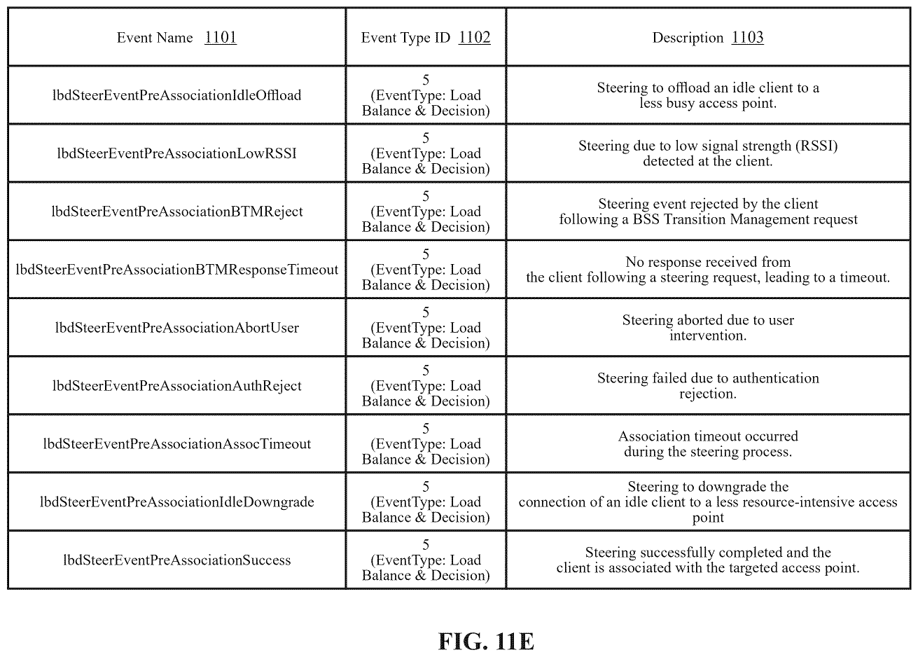

FIG. 11A, FIG. 11B, FIG. 11C, FIG. 11D and FIG. 11E are high-level conceptual diagrams illustrating an example of a table that maps events to event type identifiers, according to some aspects. The table has three columns, an event name column 1101, an event type identifier column 1102, and a description column 1103. Each row provides a mapping from an event to an event type identifier. Events having the event name shown in event name column 1101 have the event type shown in the event type identifier column 1102. As is well understood by those practiced in network administration, the event metadata in an event record (e.g., event metadata 206 in first event record 203 illustrated in FIG. 2) often includes the event name directly or includes other data that indicates the event name. As such, the event reported in each event record may be mapped to an event type identifier as shown in FIG. 11. In the example of FIG. 11, there are four event types. The number of event types and the mapping from event to event type identifier may vary in other examples.

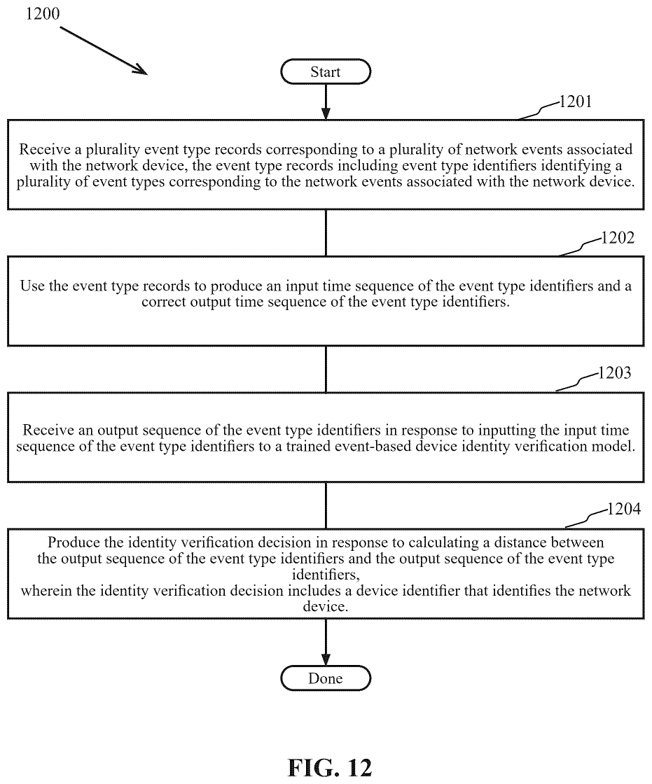

FIG. 12 is a high-level flow diagram illustrating an example of a method that produces an identity verification decision, according to some aspects. The method may be performed by a processing system (e.g., cloud server 102, host machine 301, etc.) At block 1201, a plurality event type records may be received, the event type records corresponding to a plurality of network events associated with the network device, the event type records including event type identifiers identifying a plurality of event types corresponding to the network events associated with the network device. At block 1202, the event type records may be used to produce an input time sequence of the event type identifiers and a correct output time sequence of the event type identifiers. At block 1203, an output sequence of the event type identifiers may be received in response to inputting the input time sequence of the event type identifiers to a trained event-based device identity verification model. At block 1204, the identity verification decision may be produced in response to calculating a distance between the output sequence of the event type identifiers and the output sequence of the event type identifiers, wherein the identity verification decision includes a device identifier that identifies the network device.

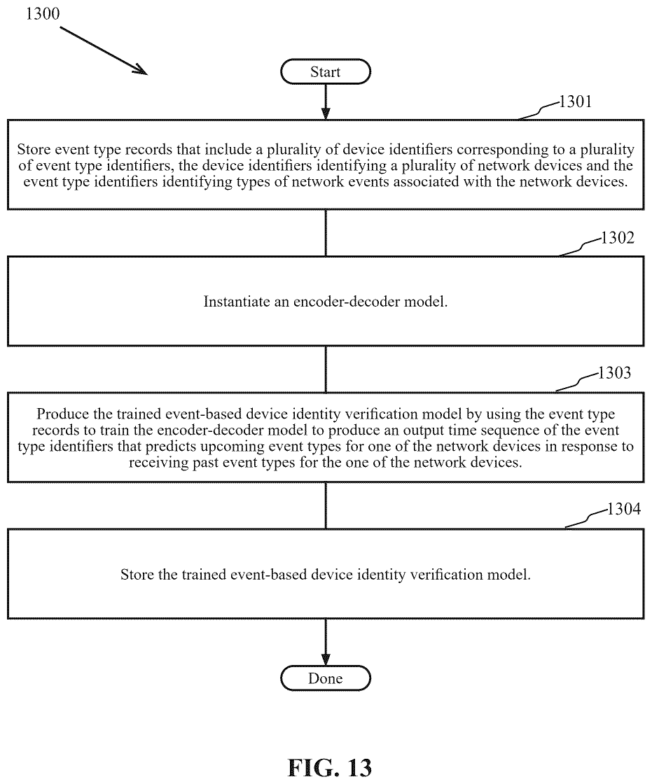

FIG. 13 is a high-level flow diagram illustrating an example of a method that produces a trained event-based device identity verification model, according to some aspects. The method may be performed by a processing system (e.g., cloud server 102, host machine 301, etc.) At block 1301, event type records may be stored. The event type records may include a plurality of device identifiers corresponding to a plurality of event type identifiers, the device identifiers identifying a plurality of network devices and the event type identifiers identifying types of network events associated with the network devices. At block 1302, an encoder-decoder model may be instantiated. At block 1303, the trained event-based device identity verification model may be produced by using the event type records to train the encoder-decoder model to produce an output time sequence of the event type identifiers that predicts upcoming event types for one of the network devices in response to receiving past event types for the one of the network devices. At block 1304, the trained event-based device identity verification model may be stored.

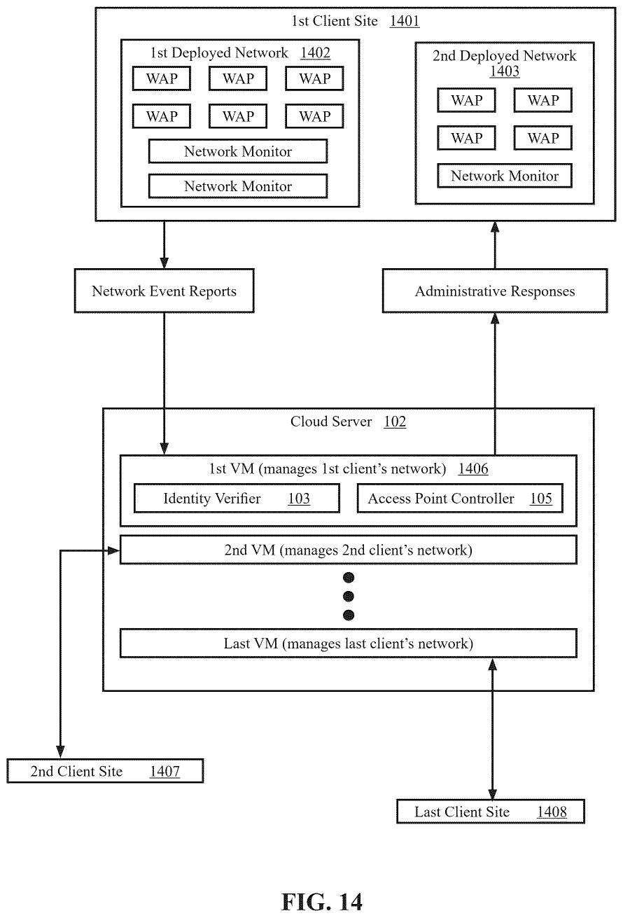

FIG. 14 a high-level flow diagram illustrating an example of a cloud service, according to some aspects. In the example shown in FIG. 14, a communications system includes a cloud server 102, and networks deployed at client sites such as a first client site 1401, a second client site 1407, and a last client site 1408. The first client site 1401 is shown with a first deployed network 1402 and a second deployed network 1403. The cloud server and/or the networks may be implemented in hardware (e.g., circuits), software, firmware, or a combination thereof. Although the illustrated communications system is shown with certain components and described with certain functionality, other embodiments of the communications system may include fewer or more components to implement the same, less, or more functionality. For example, the communications system may include more than one cloud server, and more or fewer deployed networks at more or fewer customer sites. In another example, the cloud server and the deployed networks may be connected in a topology other than that shown in FIG. 14. The cloud server 102 can be used to provide at least one service to a customer site (e.g., to the deployed networks 1402, 1403 located at the first client site 1401). The cloud server may be configured to facilitate or perform a network management service (e.g., an event-based device identity verification service) to network devices (e.g., the WAPs in the deployed networks) at the customer sites. Because the cloud server can facilitate or perform a network management service or operation for network devices at the customer site, network management efficiency can be improved. In addition, because the cloud server can facilitate or perform a network management service or operation for network devices at the customer site, event-based device identity verification may be implemented without requiring a user or customer of the client site to be trained for or to perform such tasks. Consequently, event-based device identity verification may be implemented without burdening the clients. In some examples, the cloud server may be configured to generate a user interface to obtain input information such as a floor plan of a customer site. In some examples, the user interface includes a graphical user interface. The cloud server may be implemented in hardware (e.g., circuits), software, firmware, or a combination thereof. In some examples, the cloud server is hosted or executed in a public cloud computing environment such as Amazon Web Services (AWS), and/or a private cloud computing environment such as an enterprise cloud server. In some examples, the cloud server is implemented on a server grade hardware platform, such as an x86 architecture platform.

The cloud server 102 is shown running multiple virtual machines (VMs) that may each run an event-based device identity verification service. For example, the first virtual machine (VM) 1406 is shown running an identity verifier 103 and an access point controller 105 for the deployed networks 1402, 1403 at the first client site 1401. In other examples, there may be a separate VM for each deployed network. In yet other examples, an identity verifier 103 may run in one VM and may provide identity verification services to all of the client sites. The identity verifier 103 in the first VM 1406 can produce an identity verification decision in response to receiving event records for network events occurring in the deployed networks. The access point controller 105 in the first VM can store the event records in a network event log in response to receiving network event reports. The identity verifier 103 may receive the event records by accessing the network event log.

Although the operations of the methods and processes may be shown and described in a particular order, the order of the operations may be altered so that certain operations may be performed in an inverse order or so that certain operations may be performed, at least in part, concurrently with other operations. Alternatively, instructions or sub-operations of distinct operations may be implemented in an intermittent and/or alternating manner.

While the above-described techniques are described in a general context, those skilled in the art will recognize that the above-described techniques may be implemented in software, hardware, firmware, or any combination thereof. The above-described examples may also be implemented by operating a computer system to execute a sequence of machine-readable instructions. The computer readable instructions, when executed on one or more processors, may implement a method or process. The instructions may reside in various types of computer readable media. An example of a programmed product may include a computer readable medium tangibly storing a program of machine-readable instructions executable by a digital data processor to perform a method or process. The computer readable media may comprise memory (e.g., RAM) contained within the computer. Alternatively, the instructions may be contained in another computer readable media such as a magnetic data storage diskette and directly or indirectly accessed by a computer system. Whether contained in the computer system or elsewhere, the instructions may be stored on a variety of machine readable storage media, such as a hard drive, a solid state drive, a RAID array, magnetic tape, electronic read-only memory, an optical storage device (e.g., CD ROM, WORM, DVD, digital optical tape), paper “punch” cards. In an illustrative example, the machine-readable instructions may comprise lines of compiled C, C++, or similar language code commonly used by those skilled in the programming arts.

The foregoing description of examples will so fully reveal the general nature of the various aspects that others can, by applying current knowledge, readily modify and/or adapt for various applications the examples without departing from the generic concept, and, therefore, such adaptations and modifications should and are intended to be comprehended within the meaning and range of equivalents of the disclosed examples. It is to be understood that the phraseology or terminology employed herein is for the purpose of description and not of limitation. Therefore, those skilled in the art will recognize that the examples herein can be practiced with modification within the spirit and scope of the claims as described herein.

What is claimed is:

1. A method that produces a trained event-based device identity verification model, the method comprising:
storing event type records that include a plurality of device identifiers corresponding to a plurality of event type identifiers, the device identifiers identifying a plurality of network devices and the event type identifiers identifying types of network events associated with the network devices;
instantiating an encoder-decoder model;
producing the trained event-based device identity verification model by using the event type records to train the encoder-decoder model to produce an output time sequence of the event type identifiers that predicts upcoming event types for one of the network devices in response to receiving past event types for the one of the network devices; and
storing the trained event-based device identity verification model.

2. The method of claim 1, wherein the device identifiers are media access control addresses of the network devices.

3. The method of claim 1, wherein each of the event type records includes one of the device identifiers and one of the event type identifiers.

4. The method of claim 1, wherein:
each of the event type records includes event timestamp data; and
the event timestamp data is used to train the encoder-decoder model.

5. The method of claim 4, wherein training the encoder-decoder model includes using the event timestamp data to produce position encodings that are used to train the encoder-decoder model.

6. The method of claim 5, wherein:
a first one of the network events associated with the one of the network devices occurred at a first time;
a second one of the network events associated with the one of the network devices occurred at a second time; and
one of the position encodings is a scalar that indicates an amount of time between the first one of the network events and the second one of the network events.

7. The method of claim 1, further including:
accessing a network event log that includes event records that include the device identifiers corresponding to event metadata; and
producing the event type records by mapping the event metadata to one of the event type identifiers.

8. The method of claim 1, wherein:
training the encoder-decoder model includes using the event type records to produce an input time sequence of the event type identifiers corresponding to one of the device identifiers; and
the encoder-decoder model includes an encoder that is configured to receive an encoder input that is included in the input time sequence of the event type identifiers.

9. The method of claim 8, wherein the encoder-decoder model includes a decoder that is configured to produce the output time sequence of the event type identifiers.

10. The method of claim 8, wherein the input time sequence of the event type identifiers includes the encoder input and a decoder input.

11. The method of claim 1, wherein:
producing the trained event-based device identity verification model includes using the event type records to produce a desired time sequence of the event type identifiers corresponding to one of the device identifiers; and
training the encoder-decoder model includes:
calculating a distance between the desired time sequence and the output time sequence of the event type identifiers; and
using the distance to update the encoder-decoder model.

12. A system comprising:
a processor and a memory configured to produce a trained event-based device identity verification model, wherein producing the trained event-based device identity verification model includes:
storing event type records that include a plurality of device identifiers corresponding to a plurality of event type identifiers, the device identifiers identifying a plurality of network devices and the event type identifiers identifying types of network events associated with the network devices;
instantiating an encoder-decoder model;
producing the trained event-based device identity verification model by using the event type records to train the encoder-decoder model to produce an output time sequence of the event type identifiers that predicts upcoming event types for one of the network devices; and
storing the trained event-based device identity verification model.

13. The system of claim 12, wherein the device identifiers are media access control addresses of the network devices.

14. The system of claim 12, wherein each of the event type records includes one of the device identifiers and one of the event type identifiers.

15. The system of claim 12, wherein:
each of the event type records includes event timestamp data; and
training the encoder-decoder model includes using the event timestamp data to produce position encodings that are used to train the encoder-decoder model.

16. The system of claim 15, wherein:
a first one of the network events associated with the one of the network devices occurred at a first time;
a second one of the network events associated with the one of the network devices occurred at a second time; and
one of the position encodings is a scalar that indicates an amount of time between the first one of the network events and the second one of the network events.

17. The system of claim 12, wherein:
the encoder-decoder model includes an encoder that is configured to receive an encoder input that is included in an input time sequence of event type identifiers; and
the encoder-decoder model includes a decoder that is configured to produce the output time sequence of the event type identifiers.

18. The system of claim 12, wherein:
the encoder-decoder model produces the output time sequence of the event type identifiers in response to receiving an input time sequence of event type identifiers;
the input time sequence of the event type identifiers includes a desired time sequence of the event type identifiers; and
training the encoder-decoder model includes:
calculating a distance between the desired time sequence of the event type identifiers and the output time sequence of the event type identifiers; and
using the distance to update the encoder-decoder model.

19. A non-transitory computer storage medium storing computer readable instructions that, when executed on one or more processors, implement a method comprising:
storing event type records that include a plurality of device identifiers corresponding to a plurality of event type identifiers, the device identifiers identifying a plurality of network devices and the event type identifiers identifying types of network events associated with the network devices;
instantiating an encoder-decoder model;
producing a trained event-based device identity verification model by using the event type records to train the encoder-decoder model to produce a output time sequence of the event type identifiers that predicts upcoming event types for one of the network devices in response to receiving past event types for the one of the network devices; and
storing the trained event-based device identity verification model.

20. The non-transitory computer storage medium of claim 19, wherein:
each of the event type records includes event timestamp data; and
training the encoder-decoder model includes using the event timestamp data to produce position encodings that are used to train the encoder-decoder model.
